(19) United States
(12) Patent Application Publication
(10) Pub. No.: US 2014/0123478 A1
(43) Pub. Date: May 8, 2014

(54) APPARATUS FOR ATTACHING EQUIPMENT

(71) Applicant: 1634718 Alberta Ltd., Spruce Grove (CA)

(72) Inventors: Jody Gylander, Spruce Grove (CA); Lucien Dnestrianschii, St. Albert (CA); Joseph Marcos, Edmonton (CA)

(73) Assignee: 1634718 Alberta Ltd., Spruce Grove (CA)

(21) Appl. No.: 14/067,768

(22) Filed: Oct. 30, 2013

(30) Foreign Application Priority Data
Oct. 30, 2012 (CA) 2793820

(51) Int. Cl. B25H 3/02

(52) U.S. Cl. CPC B25H 3/02
USPC 29/700; 206/372

(57) ABSTRACT

An apparatus for attaching equipment includes a base and one of a toolbox or tool accessory. The base has a primary engagement surface with a plurality of outwardly projecting male members each comprising a shaft with an enlarged head at a remote end. The toolbox or tool accessory has a secondary engagement surface with a plurality of inwardly recessed female receivers configured to receive the male members in mating relationship. A locking assembly is positioned within the toolbox or tool accessory. The locking assembly includes a movable catch that is movable between a locking position and a release position. In the locking position, the catch engages the enlarged head of each of the male members to prevent the male members from being withdrawn from the female receivers. In the release position, the catch is spaced from the enlarged heads of each of the male members.

### FIELD

There is described an apparatus for attaching equipment, such as a toolbox assembly in which a secondary toolbox or tool accessory is coupled to a base.

### BACKGROUND

U.S. Patent Publication No. 2011/0073516 (Zelinskiy) entitled “Stackable Toolbox Assembly” discloses a grouping of toolboxes that have mating connections and stack. There will hereinafter be described a toolbox assembly that is an alternative to Zelinskiy.

### SUMMARY

There is provided an apparatus for attaching equipment which includes a base and one of a toolbox or tool accessory. The base has a primary engagement surface with a plurality of outwardly projecting male members each comprising a shaft with an enlarged head at a remote end. The toolbox or tool accessory has a secondary engagement surface with a plurality of inwardly recessed female receivers configured to receive the male members in mating relationship. A locking assembly is positioned within the toolbox or tool accessory. The locking assembly includes a movable catch that is movable between a locking position and a release position. In the locking position, the catch engages the enlarged head of each of the male members to prevent the male members from being withdrawn from the female receivers. In the release position, the catch is spaced from the enlarged heads of each of the male members.

It is preferred that the movable catch be in the form of at least one movable catch plate having catch profiles which engage the enlarged head of each of the male members in the locking position. In the preferred embodiment, there are two movable catch plate sections connected by an expandable linkage. The expandable linkage selected for illustration is a scissor linkage, although it will be appreciated that other forms of expandable linkage could have been used.

In order to maintain the two movable catch plate sections in the locking position, it is preferred that the two movable catch plate sections be biased by springs toward the locking position. This then requires that the biasing force of the springs must be overcome in order to expand the linkage and move the movable catch plate sections to the release position.

In order to prevent binding, it is preferred that the movable catch plate sections each have a slotted track and the toolbox or tool accessory have a track guide configured to engage the slotted track and guide movement of the movable catch plate sections.

When it is anticipated that the apparatus will be used in adverse weather conditions, it is preferred that resilient sealing elements be positioned across each of the female recesses. Each sealing element resiliently deforming to facilitate entry of a male member. Each sealing element resiliently returns to a sealing position across the female recess when the male member is withdrawn.

In order to facilitate movement between the locking position and the release position, it is preferred that handles be provided which protrude from an exterior surface on opposed sides of the toolbox or tool accessory. The handles are connected to the movable catch plate sections. A manual pulling force exerted upon the handles serves to overcome the biasing force of the springs and move the movable catch plate sections to the release position.

In order to reduce the risk of accidental release or reduce the risk of theft, one of the handles may be provided with a first aperture and an immovable protuberance on the exterior of the toolbox or tool accessory may be provided with a second aperture. Removal of the toolbox or tool accessory from the base may be prevented by aligning the first aperture and the second aperture and extending a padlock through the apertures to secure the handles to the immovable protuberance and prevent movement of the movable catch plate sections to the release position.

In another example, the base may be a primary toolbox and the toolbox with the secondary engagement surface may be a secondary toolbox.

In another example, the base may have a connection that connects to a tailgate of a truck.

In another example, the plurality of outwardly projecting male members may be selectively retractable within the base. Each projecting male member is refracted and extended using a sloped surface that moves laterally within the base and applies an extending force to the corresponding projecting male member.

In another example, the tool accessory may comprise at least one of a fuel container, a rack accessory, vice grips, and power tools.

In another example, the base may comprise a top surface of a truck toolbox that has attachments for mounting in a box of a truck.

In another example, the base may comprise a modular surface that can be connected to additional modular surfaces.

According to a further aspect, there is provided a toolbox, comprising a toolbox body having a bottom, a top cover and a surrounding sidewall, the toolbox body defining an inner enclosure, and the top cover comprising a first locking element. There is at least one handle on the surrounding sidewall adjacent to the first locking element, and the handle carrying a second locking element that selectively engages the first locking element, the handle being mounted to the toolbox body by a linkage. The linkage comprises a pivoting axis that permits pivotal movement of the handle between an operative pivotal position and a locking pivotal position and a sliding actuator that permits lateral movement of the handle between a first lateral position and a second lateral position, wherein, in the locking pivotal position, the handle is restricted from laterally moving from the second lateral position to the first lateral position and the second locking element engages the first locking element to fix the position of the top cover.

In another example, the toolbox may comprise a secondary lock for locking the at least one handle in the locking pivotal position.

In another example, the secondary lock may comprises an aperture in the handle sized to receive a padlock.

In another example, the bottom of the toolbox body may further comprise at least one mounting lock that removably locks to a locking surface, wherein movement of the at least one handle to the first lateral position releases the mounting lock from the locking surface.

In another example, in the first lateral position, the at least one handle may be retracted toward the inner enclosure and each handle may be connected by a lever to the respective mounting lock, such that the movement of the at least one handle to the first lateral position releases the at least one mounting lock.

In another example, in the first lateral position, the handle may be refracted toward the inner enclosure.

In another example, in the first lateral position, the handle may be restricted from pivotally moving from the operative pivotal position to the locking pivotal position.

These and other features will be apparent from the specification and claims.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top perspective view of an apparatus for attaching equipment in the form of a toolbox assembly, for purpose of illustration assembly including a primary toolbox, a secondary toolbox, and accessories in the form of a rack and two fuel containers.

FIG. 1A is a side elevation view of the primary tool box illustrated in FIG. 1.

FIG. 2 is a front perspective view of the primary toolbox illustrated in FIG. 1.

FIG. 2A is a detailed side elevation view in section of a handle of the primary tool box in a locked position.

FIG. 2B is a detailed side elevation view in section of a handle of the primary tool box in an unlocked position.

FIG. 3 is a rear perspective view of the primary toolbox illustrated in FIG. 1.

FIG. 4 is a front perspective view of the primary toolbox illustrated in FIG. 1, with drawer opened.

FIG. 5 is a side elevation view of the primary toolbox illustrated in FIG. 4.

FIG. 6 is a detailed perspective view of the male member, which is mounted on the primary toolbox illustrated in FIG. 1.

FIG. 7 is a bottom perspective view of the secondary toolbox illustrated in FIG. 1.

FIG. 8 is a top perspective view of the secondary toolbox illustrated in FIG. 7, with lid raised.

FIG. 9 is a top perspective view of the secondary toolbox illustrated in FIG. 7, with both lid and false bottom removed to reveal locking assembly detail.

FIG. 10 is a bottom plan view, in section, of the secondary toolbox illustrated in FIG. 7, with bottom removed to reveal locking assembly detail.

FIG. 11 is a top perspective view of the locking assembly of the secondary toolbox illustrated in FIG. 7.

FIG. 12 is a bottom perspective view of the locking assembly of the secondary toolbox illustrated in FIG. 11.

FIG. 13 is an exploded perspective view of the locking assembly illustrated in FIGS. 11 and 12.

FIG. 14 is a side elevation view, in section, of the male member from the primary toolbox illustrated in FIG. 6 mated with the locking assembly of the secondary toolbox.

FIG. 15 is a bottom perspective view of the rack accessory illustrated in FIG. 1.

FIG. 16 is a bottom perspective view of the fuel container illustrated in FIG. 1.

FIG. 17 is a top perspective view of a work platform.

FIG. 18 is a side elevation view of the work platform illustrated in FIG. 17.

FIG. 19 is a detailed side elevation view, in section, of the work platform illustrated in FIG. 17.

FIG. 20 is a detailed view of the handle on the work platform illustrated in FIG. 17.

FIG. 21 is a top perspective view of a further example of a toolbox assembly.

FIG. 22 is a top perspective view of the secondary tool box with an open lid.

FIG. 23 is a front elevation view of the secondary tool box.

FIG. 24 is a bottom plan view of the secondary tool box.

FIGS. 25 and 26 are perspective views of the secondary tool box.

FIGS. 25A and 26A are end plan views of the secondary tool box showing the handle in a locked pivotal position and an unlocked pivotal position.

FIG. 27 is a top perspective view of the inside of the secondary tool box.

FIG. 27A is a side elevation view in section of the secondary tool box showing details on the handle and the locking mechanism.

FIG. 28 is an exploded view of an alternative locking mechanism.

FIG. 29 is a top perspective view of the locking mechanism of FIG. 28.

FIG. 30 is a bottom perspective view of the locking mechanism of FIG. 28.

FIG. 31 is an exploded view of a further alternative locking mechanism.

FIG. 32 is a bottom perspective view of the locking mechanism of FIG. 31.

FIG. 33 is a top perspective view of the locking mechanism of FIG. 31.

FIGS. 34 and 35 are top plan views of the locking mechanism of FIG. 31 in the locked an unlocked positions.

FIG. 36 is a perspective view of an alternative headache rack.

FIG. 37 is an end elevation view of the alternative headache rack of FIG. 36.

FIG. 38 is a front elevation view of an alternative headache rack of FIG. 36.

FIG. 39 is a perspective view of an alternative male member.

FIG. 40 is a perspective view of a tile used to make a base.

FIG. 40A is a perspective view of a base made from a plurality of tiles.

FIGS. 41 and 42 are side elevation views in section of alternative engagements of the male member and the locking mechanism.

### DETAILED DESCRIPTION

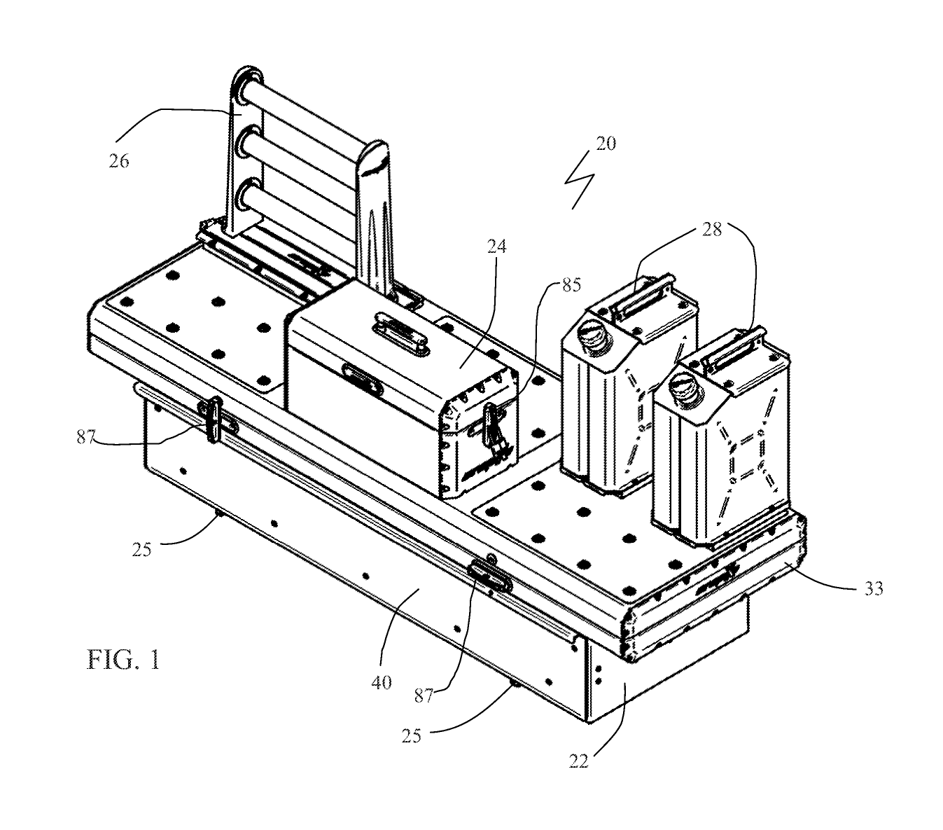

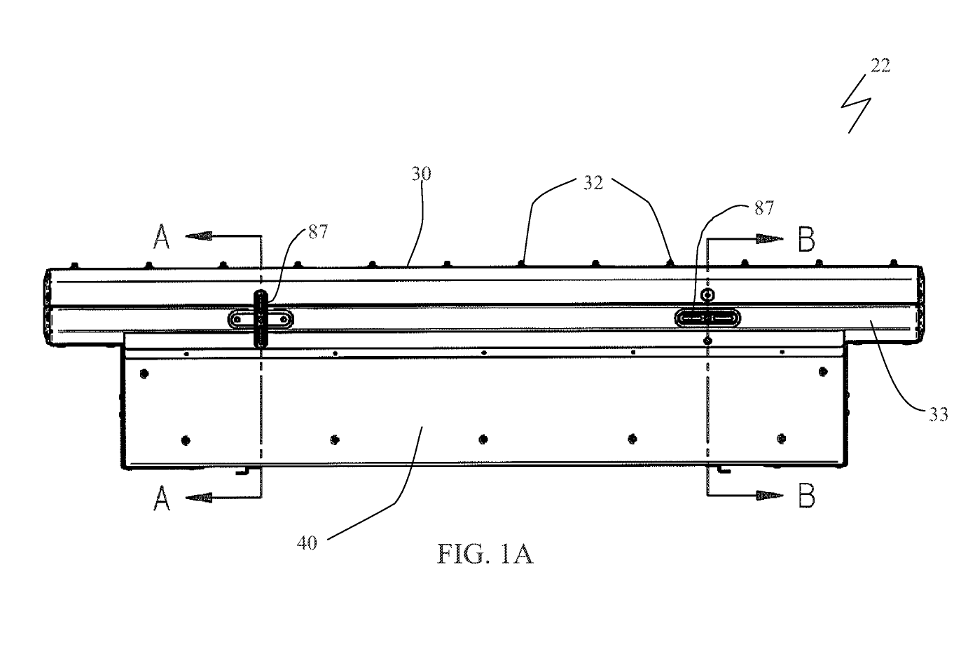

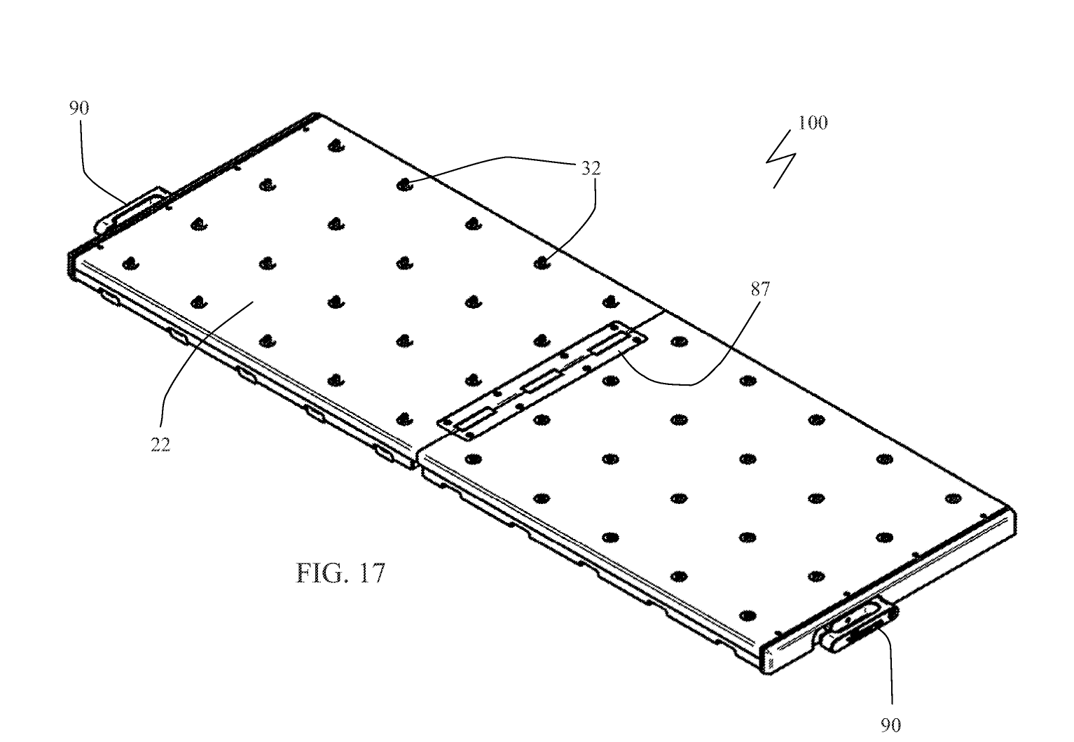

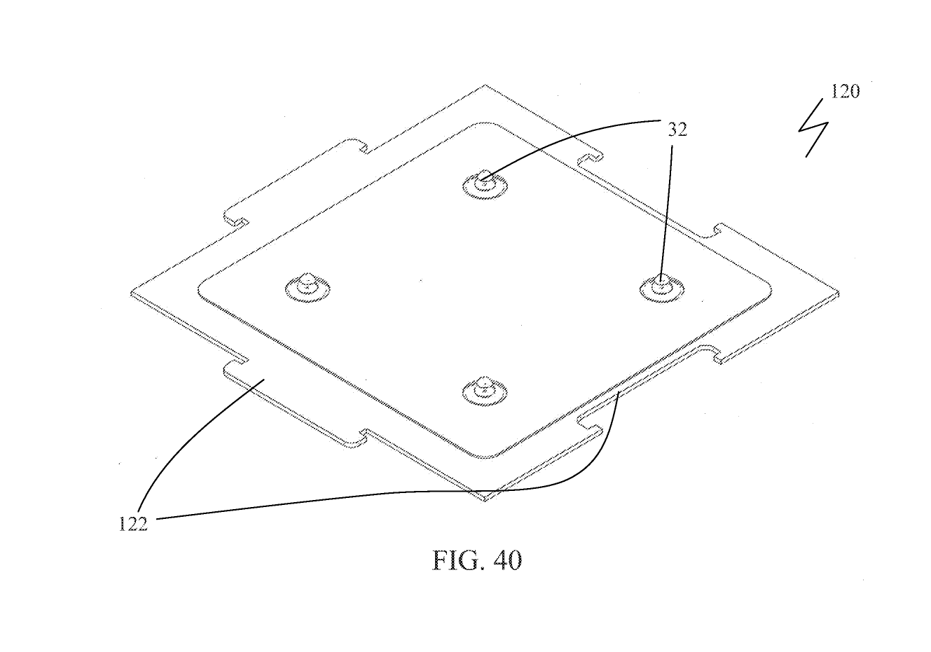

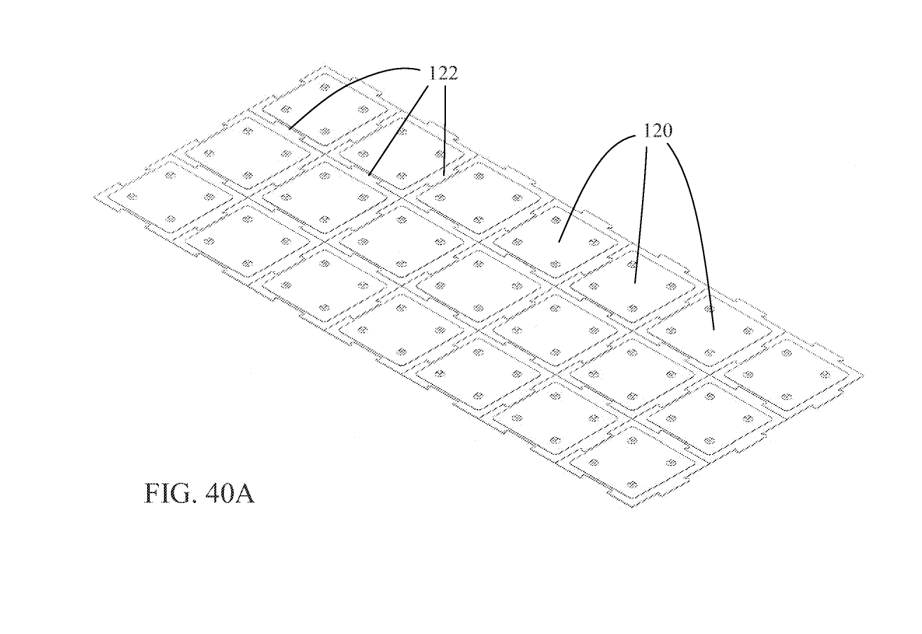

An apparatus for attaching equipment will now be described. Referring to FIG. 1, the apparatus is shown as a toolbox assembly 20 depicted in FIG. 1 includes a base 22, shown as a primary toolbox, and one or more secondary toolboxes 24 or accessories. Chosen for illustration as other possible accessories that a user may use are a rack accessory 26, or “headache rack” and fuel containers 28. Other tool accessories (not shown) may include vice grips, power tools, etc. Base 22 in the depicted embodiment has attachments 25 on the underside for mounting the toolbox assembly 20 in the box of a truck. Other attachments may also be provided on the sides of base 22 that engage the top of a truck box, or any other convenient location. Base 22 is not necessarily a primary toolbox. For example, base 22 may be another type of container or storage box, a shelf, a work surface as shown in FIG. 17, or it may be a modular surface, such as a tile 120 as shown in FIG. 40. The latter two options are described in more detail below. Other options will also be apparent to those skilled in the art as those described below are illustrative examples only.

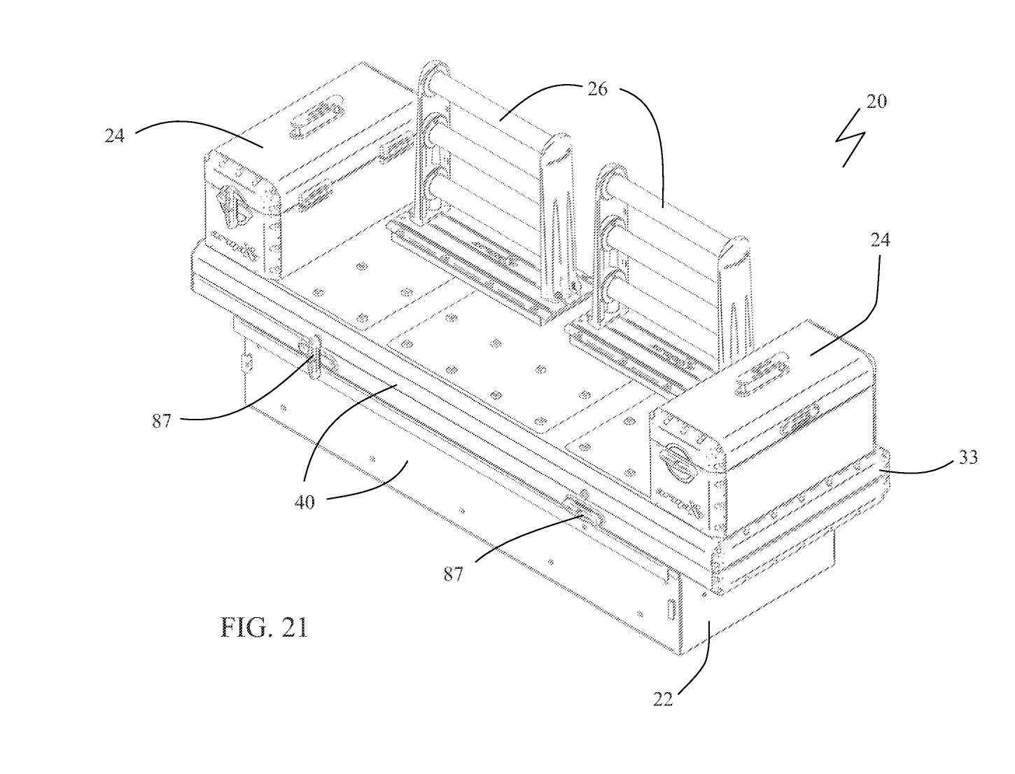

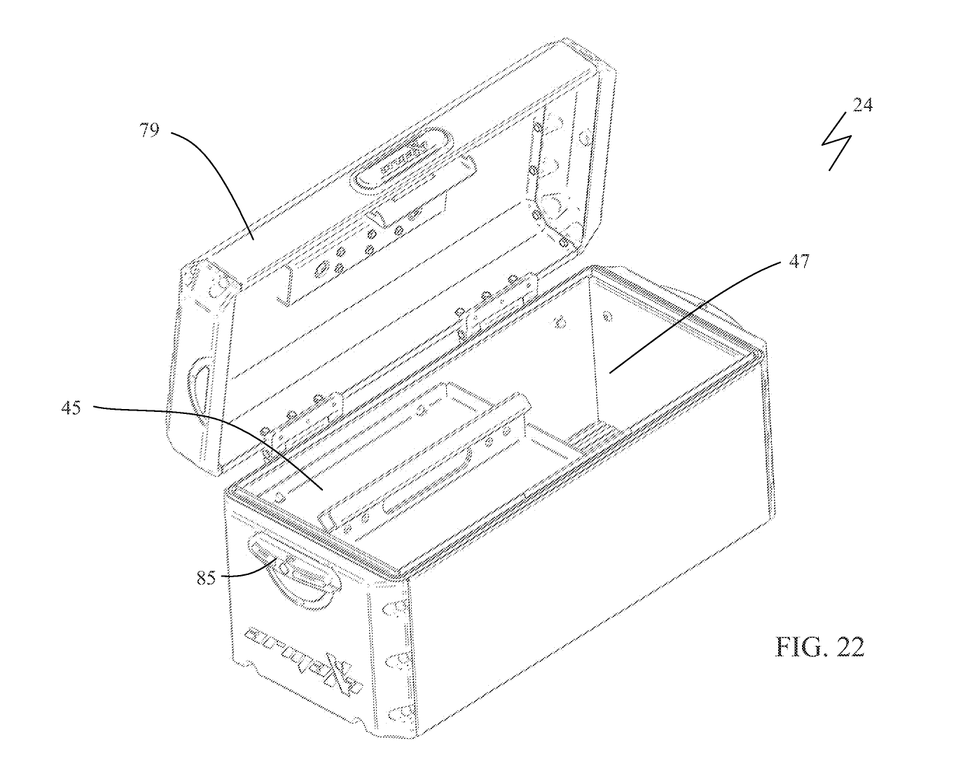

Referring now to FIG. 21, equipment may be attached as desired on the upper surface of primary toolbox 22 As shown, primary toolbox 22 has multiple secondary toolboxes 24 attached. Preferably, the spacing between panels are such that the accessories used on primary toolbox 22 need not be mounted on separate panels of the primary engagement surface 30, but may also span the panels as is shown with the rack accessories 26. Furthermore, the accessories are designed with a common pattern such that they may be attached in any preferred location, as desired by the user.

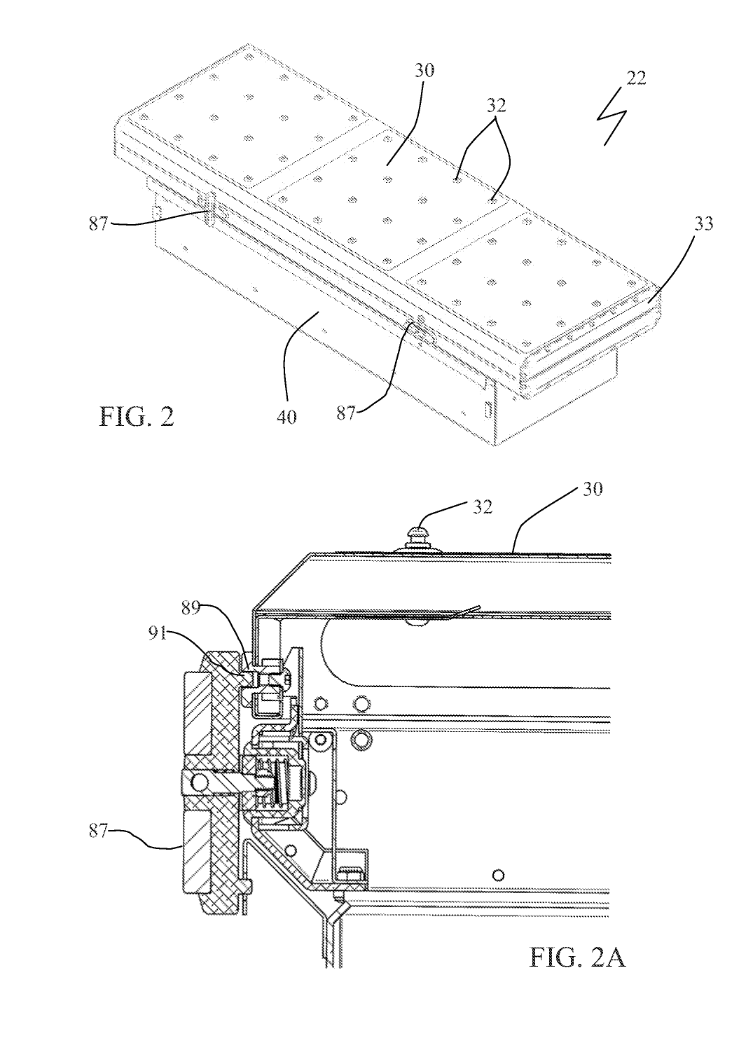

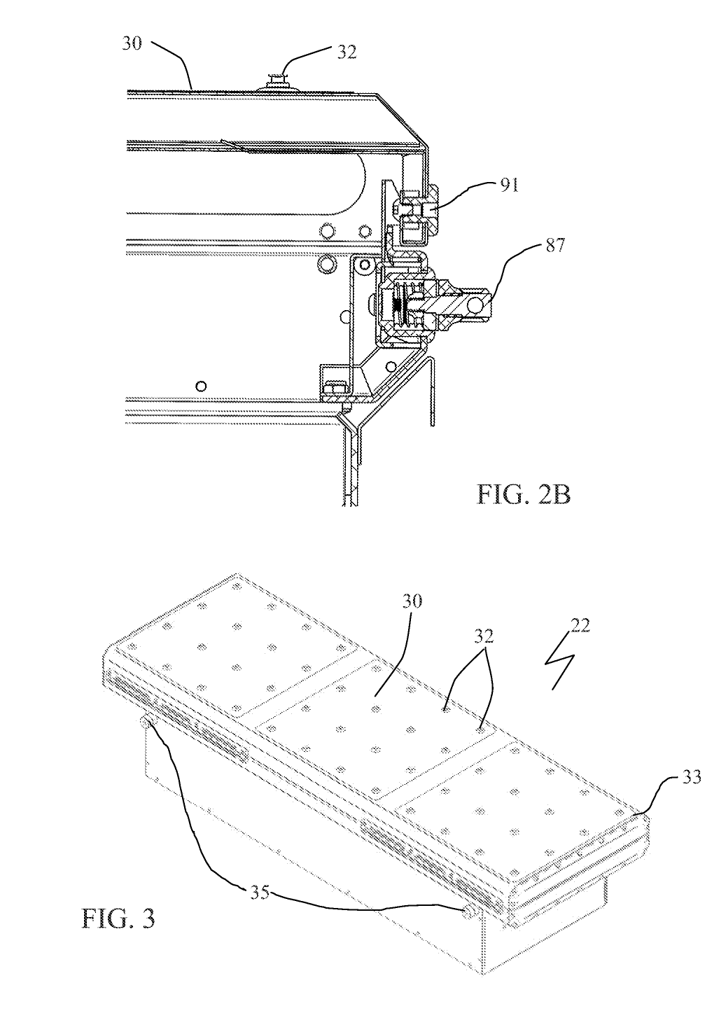

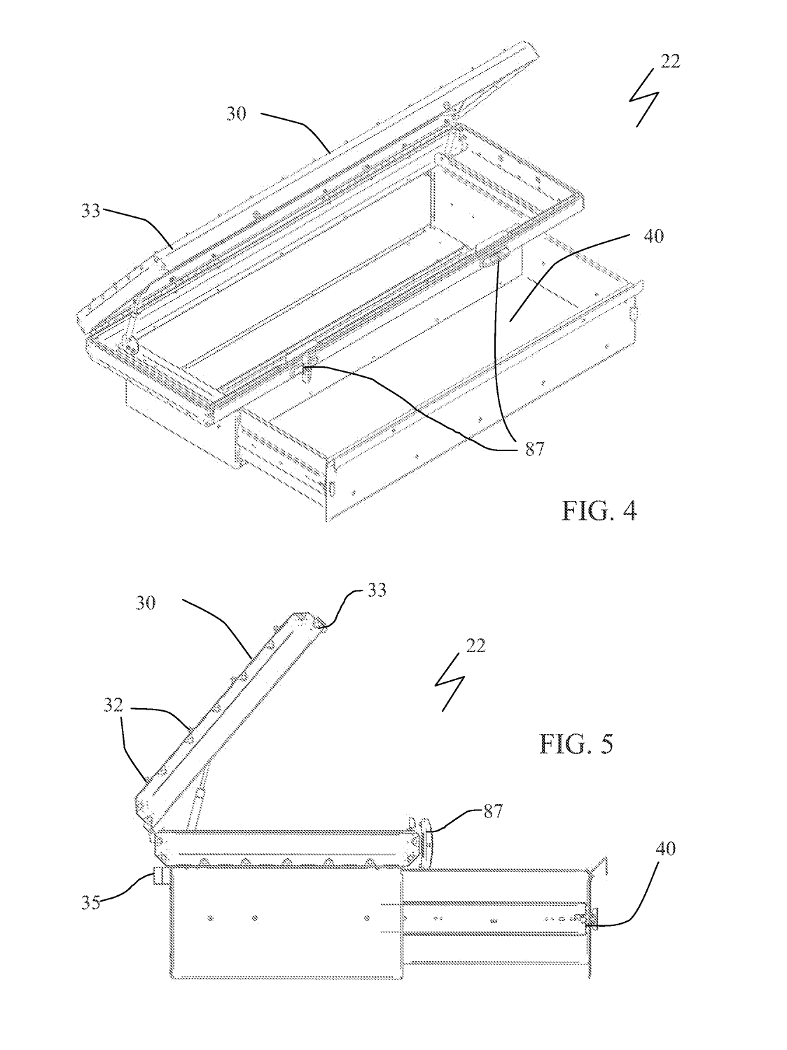

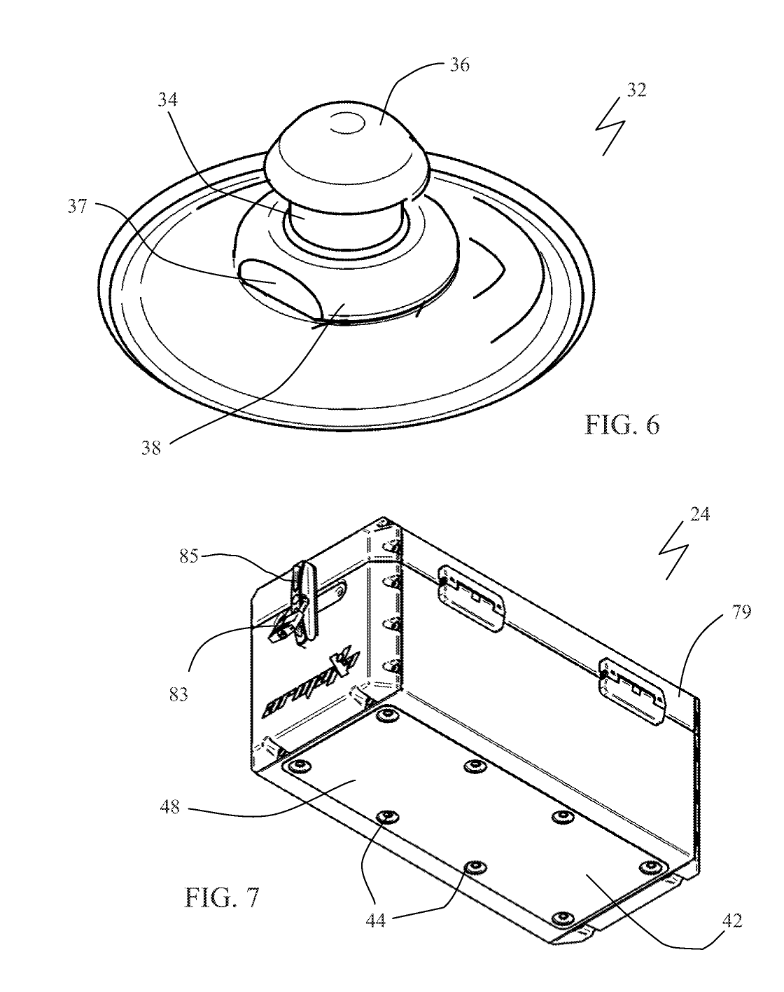

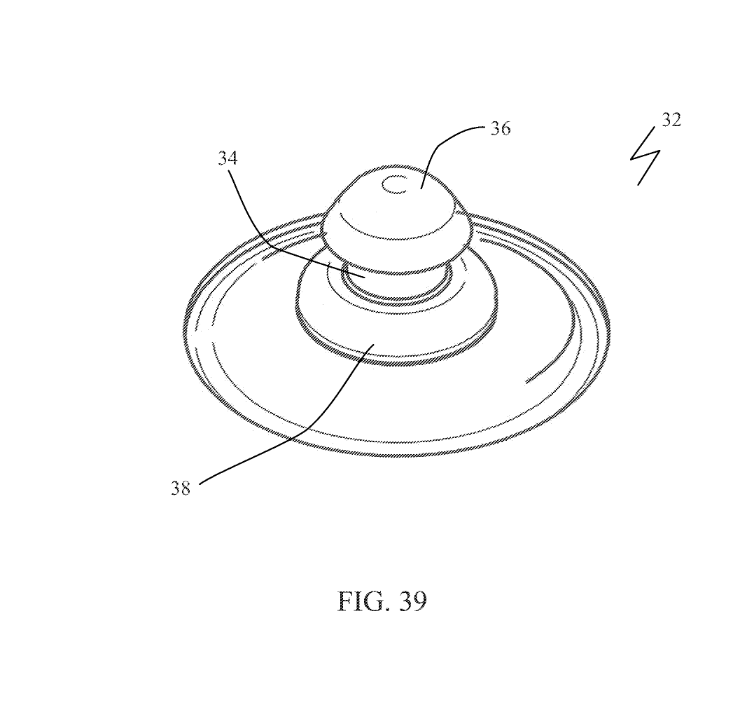

Primary toolbox 22 is illustrated in FIGS. 1A-5. Referring to FIG. 2, primary toolbox 22 has a primary engagement surface 30 with a plurality of outwardly projecting male members 32. FIG. 1A depicts the outward projection of the male members 32. Referring to FIG. 6, each male member 32 has a shaft 34 with an enlarged head 36 at a remote end 38. Referring to FIG. 39, another example of male member 32 is shown. In the example depicted in FIG. 6, male member 32 has been provided with an engagement profile 37 that may be engaged by a wrench or other tool. This may be preferably if male members 32 are threaded into place or if a particular design of male members 32 is such that the orientation is important. If male members 32 are installed by, for example, riveting or welding, engagement profile 37 may not be required, as in FIG. 39. Referring to FIG. 4 and FIG. 5, in the illustrated embodiment primary engagement surface 30 is the top surface. This top surface is fixed, although it may be mounted to a lid 33 that raises and lowers to provide additional storage space or that provides an alternate access to a drawer 40 in toolbox 22. As lid 79 generally can only be raised when nothing is mounted to lid 33, preferably it is simply an alternate access to drawer 40. Referring to FIG. 3, tool box 22 preferably has stops 35 that prevent tool box 22 from being located too closely to the cab of a truck and risk damage to a rear window.

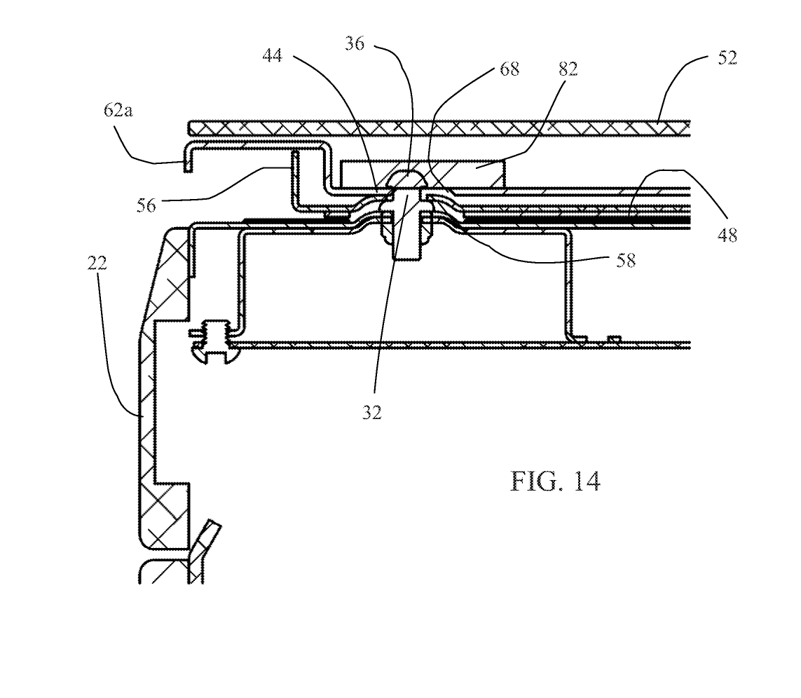

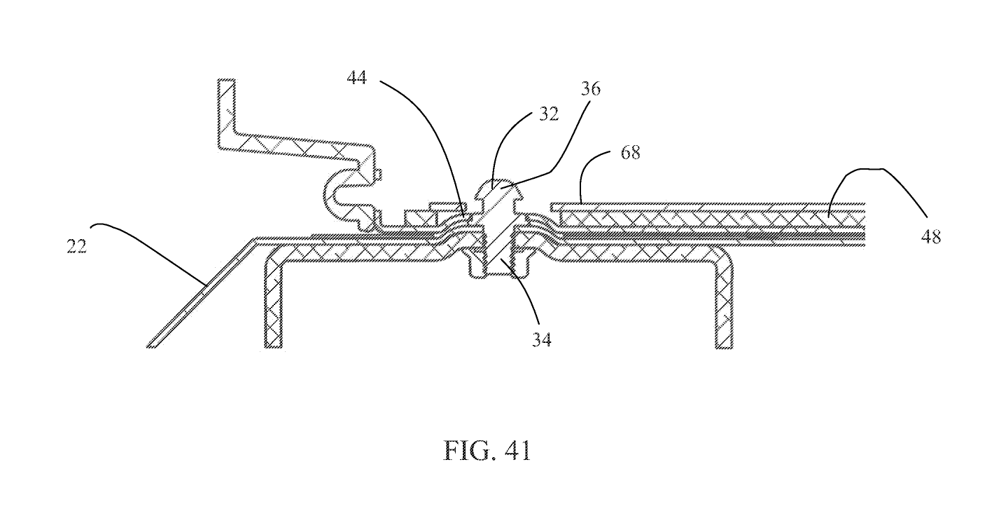

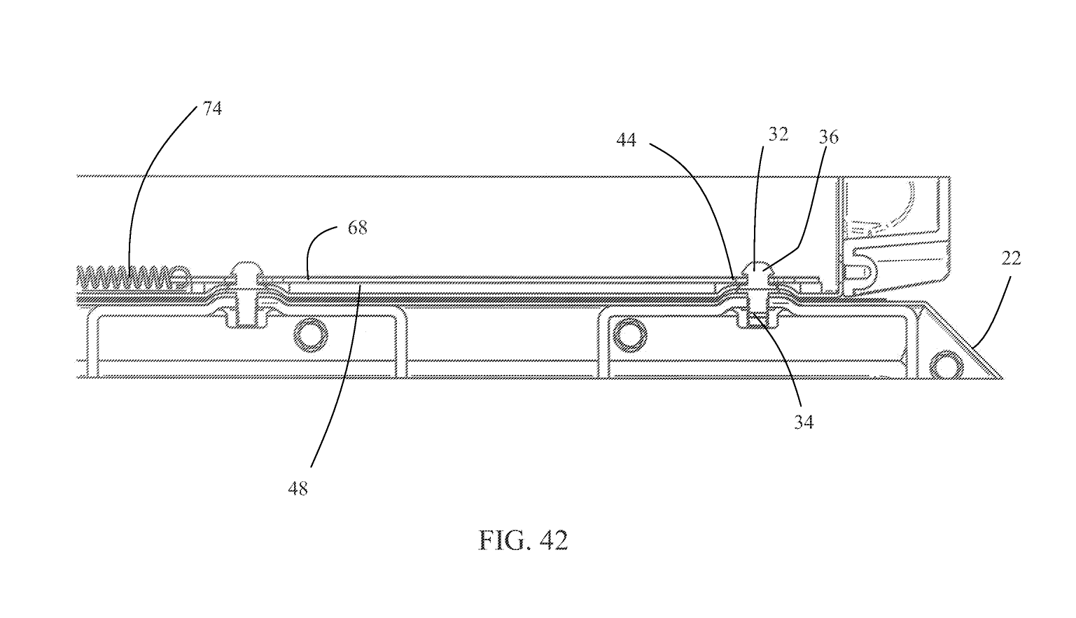

As mentioned above, various accessories may be mounted to base 22. As an example, secondary toolbox 24 is illustrated in FIGS. 7-10. Referring to FIG. 7, secondary toolbox 24 has a secondary engagement surface 42 with a plurality of inwardly recessed female receivers 44. Referring to FIG. 14, female receivers 44 are configured to receive male members 32 in mating relationship. Another example of the locking assembly with female receivers 44 configured to receive male members 32 in mating relationship is shown in FIG. 41. A further example of the locking assembly is shown in FIG. 42.

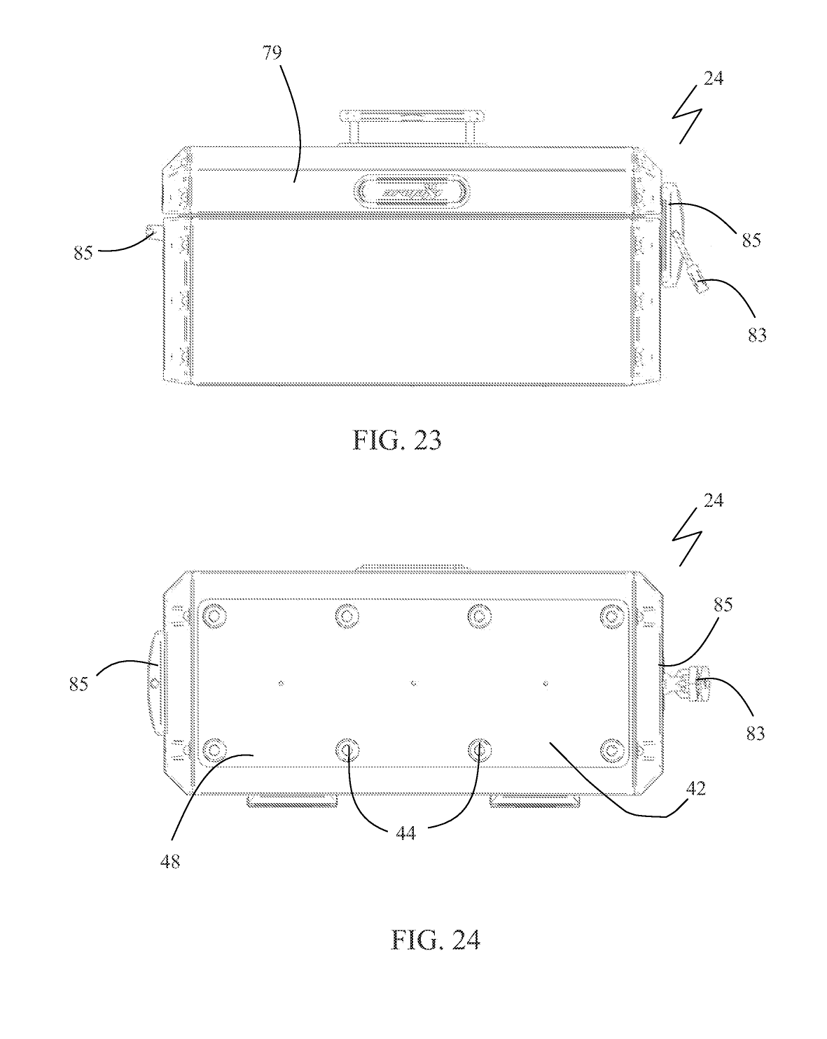

Referring to FIGS. 22-27, secondary tool box 24, including its interior, may be configured in different ways, based on the preferences of the user or manufacturer. For example, as shown in FIG. 22, secondary toolbox may have further accessories in the interior, such as the depicted tray 45.

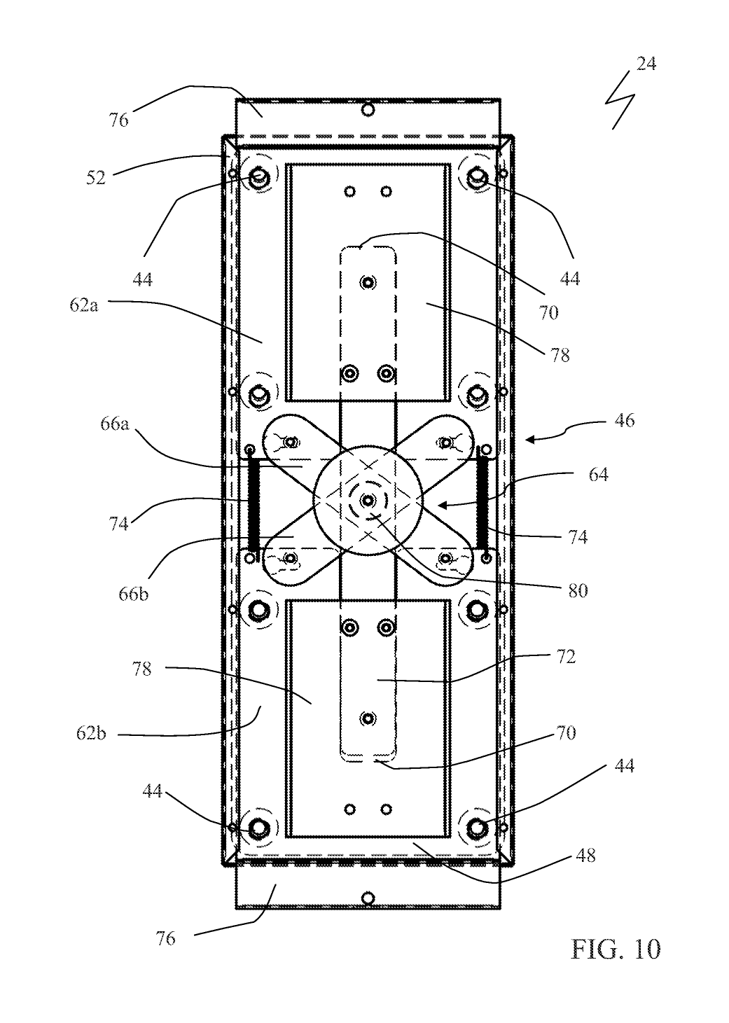

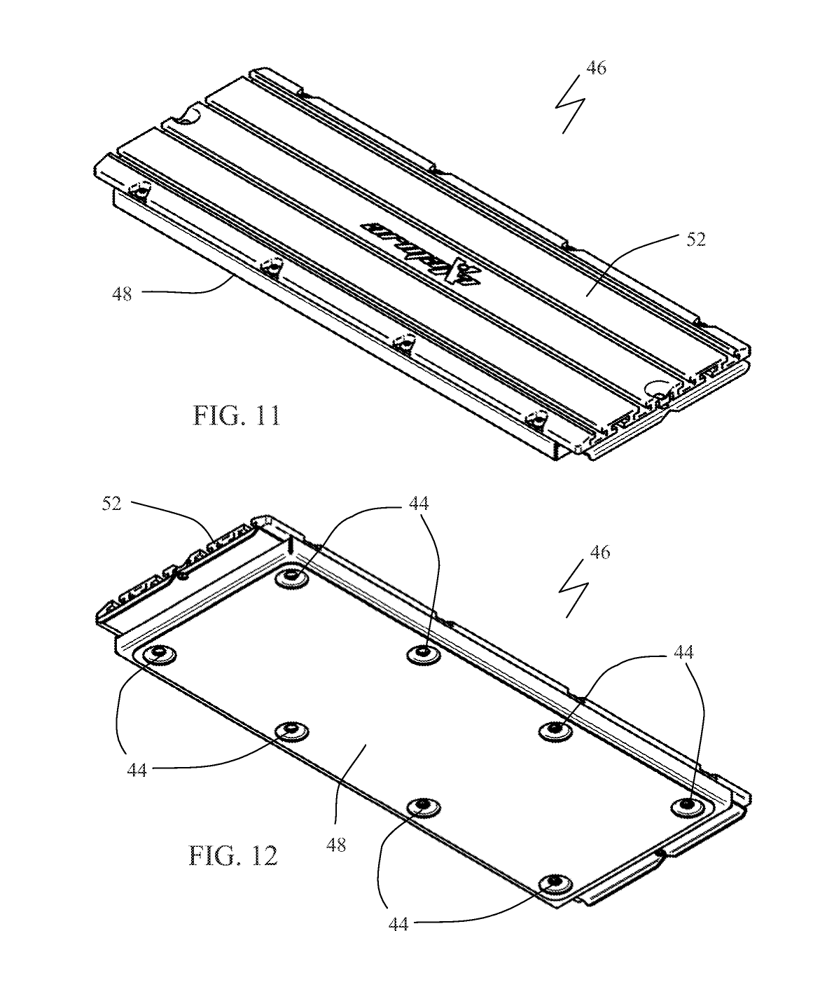

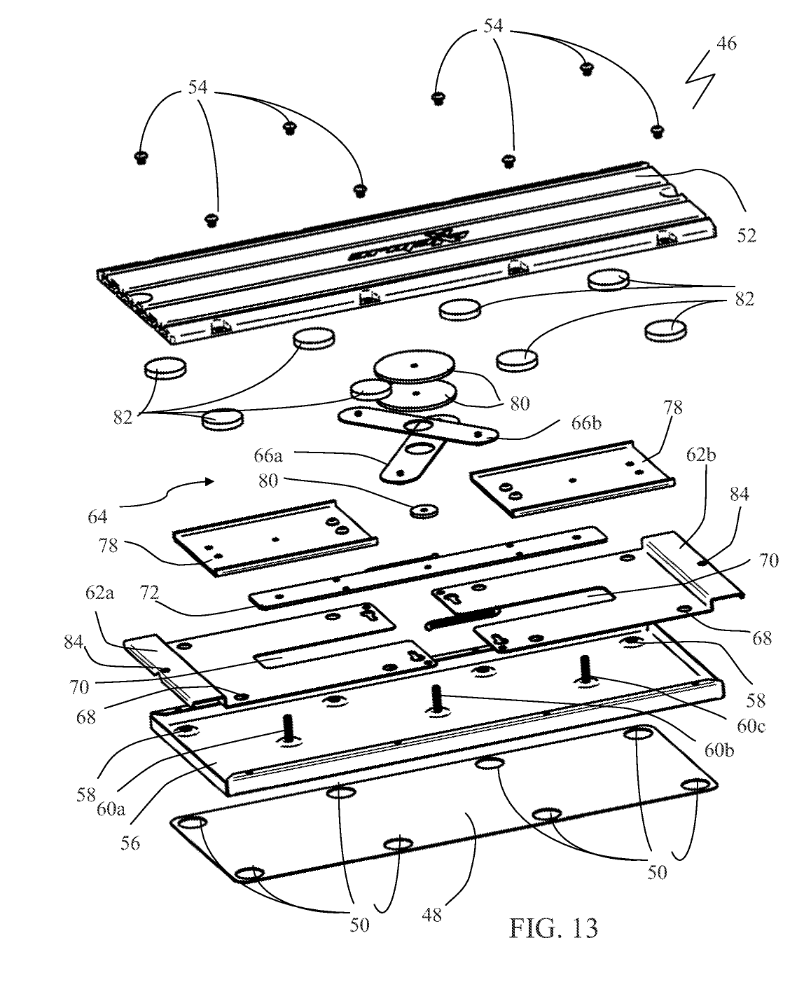

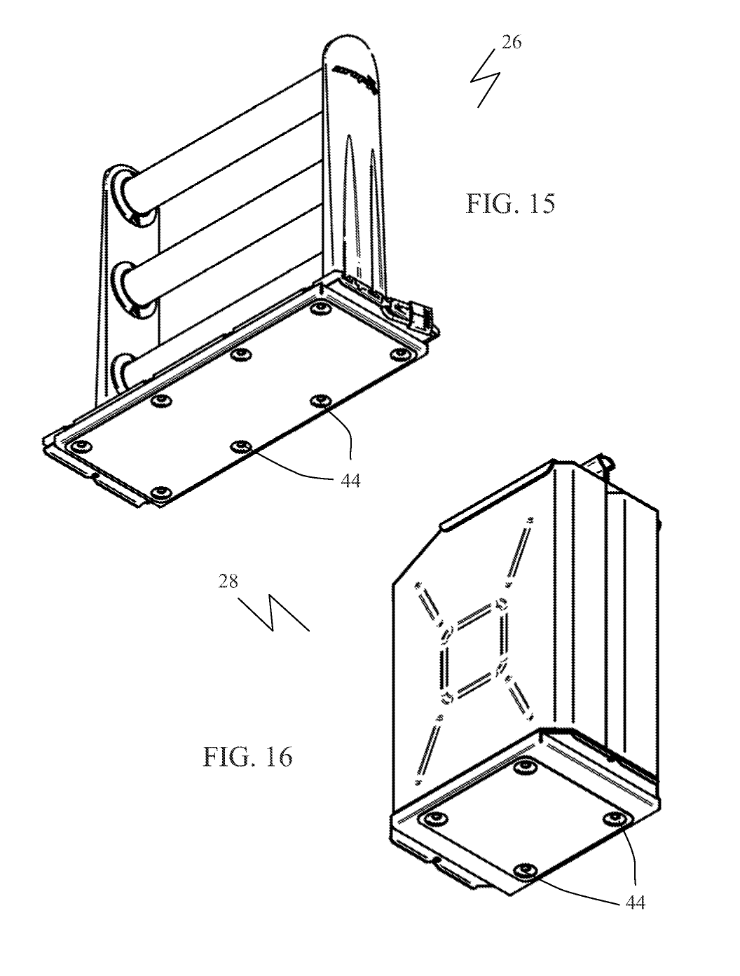

Referring to FIGS. 9-14, a locking assembly, generally indicated by reference numeral 46 is depicted in relation to secondary toolbox 24. A similar locking assembly is used for other types of tool accessories as well, as shown in FIGS. 15 and 16. Referring to FIG. 13, an exploded view is provided to facilitate identification of all of the components of locking assembly 46. A bottom of secondary toolbox 24 is identified by reference numeral 48. Bottom 48 has a plurality of peripheral openings 50. A false bottom visible from inside secondary toolbox 24 is identified by reference numeral 52. False bottom 52 is secured in position by a plurality of screws 54 and acts to hide and protect the internal components of locking assembly 46. An immovable locking assembly underlying support 56 is positioned adjacent bottom 48 of secondary toolbox 24. Locking assembly underlying support 56 has recesses 58 which are in register with openings 50 in bottom 48. Locking assembly underlying support 56 also has three upstanding members 60a, 60b, and 60c. There are two movable catch plate sections 62a and 62b connected by an expandable scissor linkage, generally indicated by reference numeral 64. Expandable scissor linkage 64 has two arms 66a and 66b, which pivot about a pivot axis provided by upstanding member 60b. Each of movable catch plate sections 62a and 62b have openings that serve as catch profiles 68. Referring to FIG. 10, expandable scissor linkage 64 is shown in its operative position for facilitating movement of catch plate sections 62a and 62b toward and away from each other. The movement is a sliding movement between a locking position and a release position. Referring to FIG. 14, catch profiles 68 engage enlarged head 36 of each of male members 32 when in the locking position. Referring to FIG. 13, catch plate sections 62a and 62b each have a slotted track 70. An elongated track guide 72 is provided to engage the slotted track 70 and guide movement of catch plate sections 62a and 62b. Referring to FIG. 10, the relationship between slotted track 70 of catch plate sections 62a and 62b and track guide 72 is illustrated. Springs 74 extend between catch plate sections 62a and 62b to bias catch plate sections 62a and 62b into the locking position. In order to move catch plate sections 62a and 62b from the locking position into the release position, a force must be exerted upon handle portions 76 of catch plate sections 62a and 62b, which extend from secondary toolbox 24. Referring to FIG. 13, in order to prevent slotted track 70 of catch plates sections 62a and 62b from separating from track guide 72, overlying guide plates 78 are provided which attach to track guide 72. Washers 80 are provided to facilitate pivotal movement of expandable scissor linkage 64. In order to facilitate use in adverse weather conditions, resilient sealing elements 82 are provided. Referring to FIG. 14, sealing elements 82 are positioned across each of the female recesses 58. Each sealing element 82 resiliently deforms to facilitate entry of male member 32. Each sealing element 82 resiliently returns to a sealing position across female recess 58 when male member 32 is withdrawn.

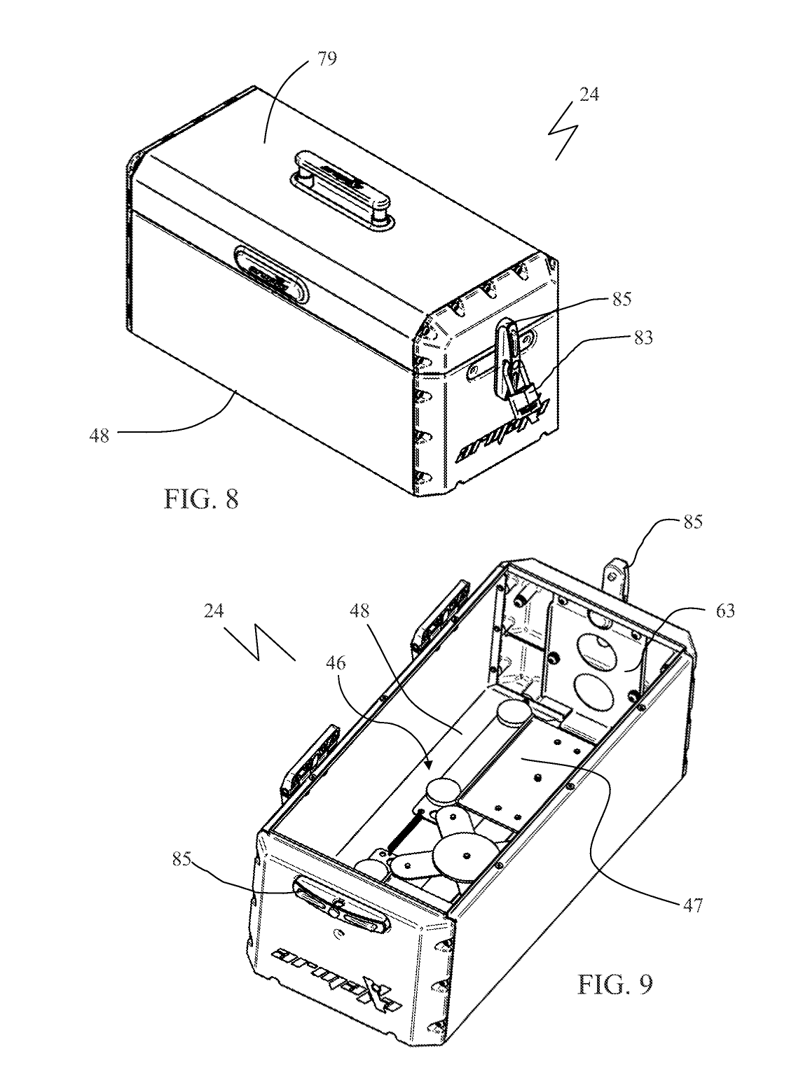

Referring to FIG. 13, catch plate sections 62a and 62b have an aperture 84. The movement of catch plates 62a and 62b may be controlled by handles 85 on the sides of secondary tool box 24. Handles 85 may be pulled out and rotated to a vertical orientation to lock tool box 24 in place as shown on the right hand side of FIG. 9, or rotated horizontal and pushed in to unlock toolbox 24 as shown on the left hand side of tool box 24. To ensure tool box 24 is not released accidentally or to prevent theft, a padlock 83 or other locking device may be used to secure handle 85 in the locked position, as shown in FIG. 8. As shown in FIG. 9, the handles 85 are connected to the catch plates 62a and 62b by an actuator, depicted as a plate 63 that acts as a lever. This lever or levers 63 is preferably attached to the movable catch plate sections 62a and 62b such that they can be released by either pushing or pulling on the handles 85, depending on the orientation of the lever 63. As depicted, levers 63 move to a release position as handles 85 are pressed into or toward toolbox 24. In this example, a scissor linkage 64 has been provided such that it is only necessary for one handle 85 to be movable.

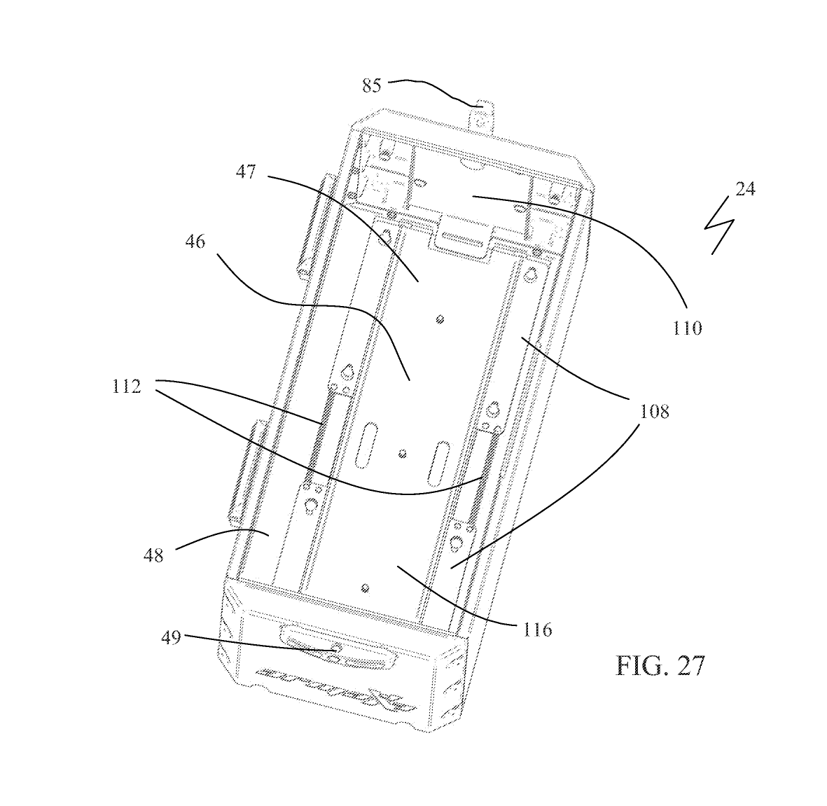

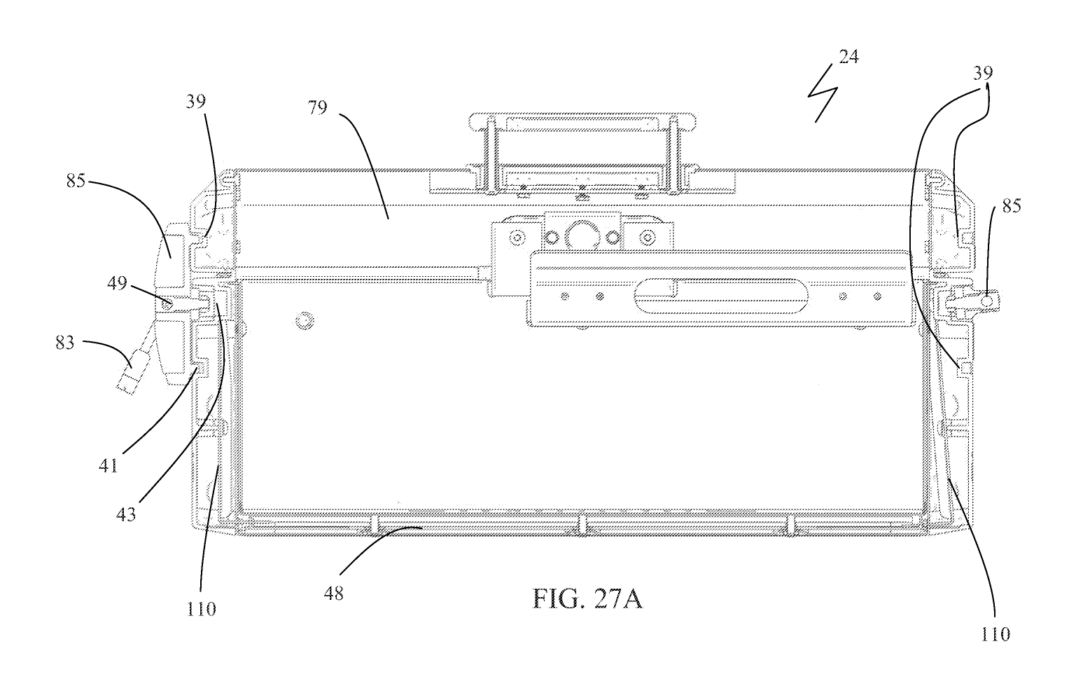

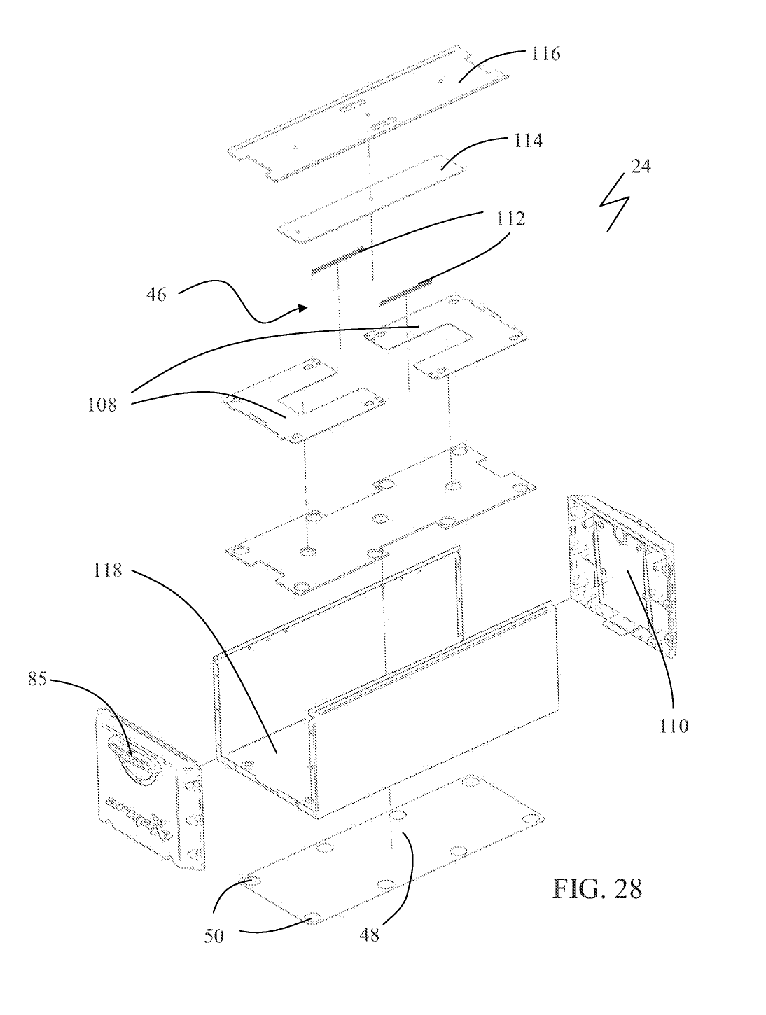

Referring to FIGS. 27 and 28, alternative locking assemblies 46 may be used in any of the toolboxes or accessories. In the depicted embodiment the locking assembly 46 has cantilevered panels 110 that attach each handle 85 to a catch plates 108, two of which are shown. Catch plates 108 are moved to a release position by moving toward the respective end of toolbox 24 and attached together by springs 112 such that they bias each other towards the locked position. In this embodiment, catch plates 108 move independently such that a force must be applied to each in order to move it to the release position. As seen in FIG. 28, catch plates 108 are aligned by a travel guide plate 114 and held in place by a cover plate 116. The catch plates 108 are mounted over base plate 118 which mounts on the base of the toolbox 24 and engages the male members 32 through the bottom 48 that has openings 50. When handles 85 have external pressure applied they recess into toolbox 24, causing the cantilevered panel 110 to pull the catch plates 108 against springs 112 causing plates 108 to move away from each other and towards opposite ends of toolbox 24. This movement of the plates 108 releases the locking mechanism from male members 32 and they are released and the toolbox 24 may be removed.

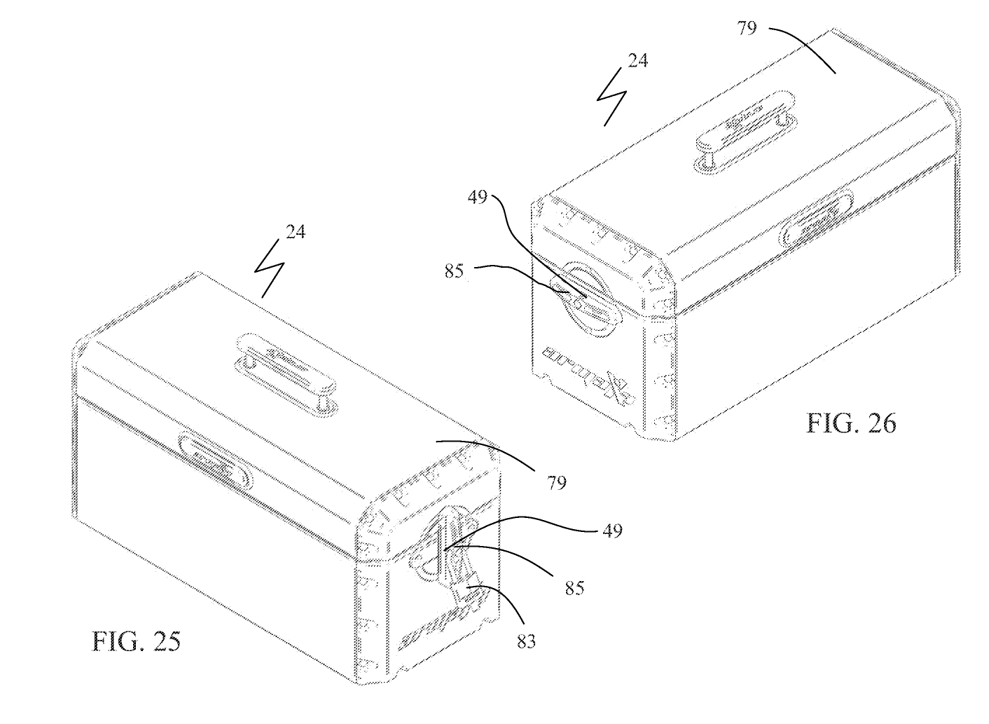

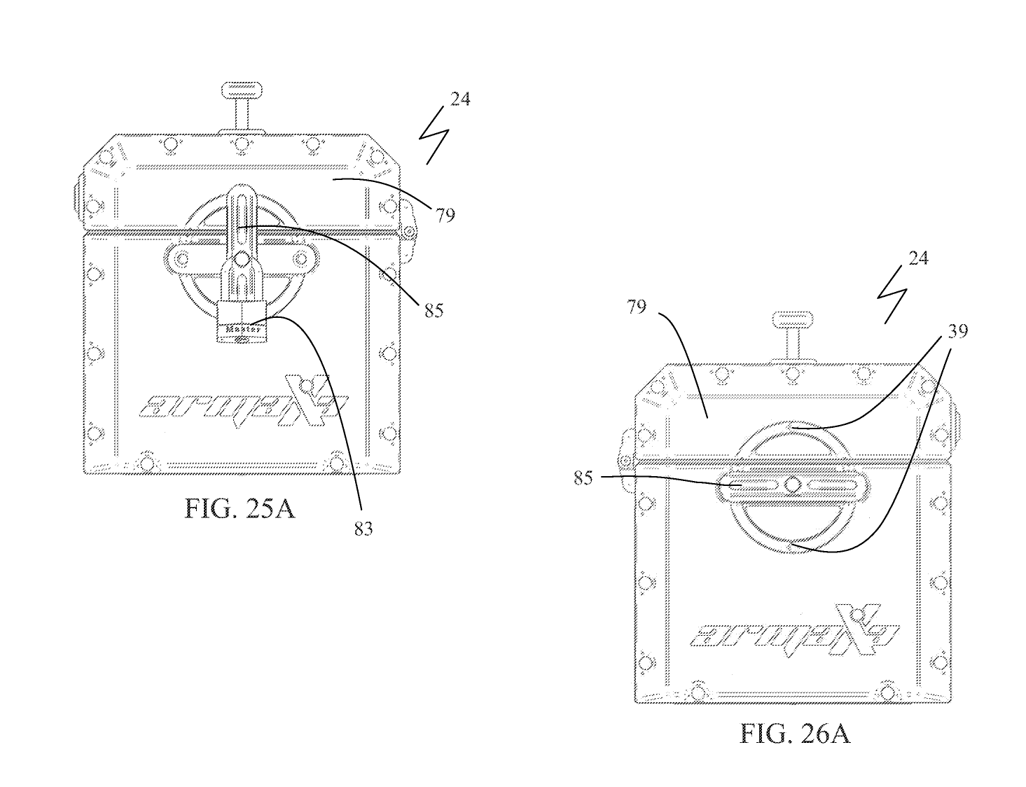

As shown in FIG. 25, handles 85 may also be used to lock the top cover 79 of the toolbox 24 to prevent theft or accidental opening during transportation. In some embodiments, the locking mechanism for the cover 79 and the locking mechanism for the mounting lock may both use the handles 85. In this preferred example, tool box 24 may be both locked to base 20 and have top cover 79 locked using the same mechanism. Toolbox 24 has a first locking element 39 and the handle 85 has a second locking element 41 that acts to selectively engage the first locking element and are shown in FIG. 27A. As shown, first locking element 39 is an indent in top cover 79. A corresponding indent is also found in the body of toolbox 24 and second locking element 41 is a pin that is received within the indents. When engaged, handle 85 is prevented from being rotated to allow cover 79 form being opened and from moving laterally toward the toolbox 24. Alternatively, first locking element may be a slotted pin (not shown) that is engaged by a receiving slot carried by handle that receives the first locking element as it is rotated toward it. Other locking designs may also be used. For example, second locking element may have a cavity that receives first locking element as handle 85 is pulled away from toolbox 24 and placed over first locking element. In these examples, handle 85 is pivotally mounted to the toolbox 24 by a linkage 43. This provides a pivoting axis such that the handle 85 may move between an operative pivotal position as in FIGS. 26 and 26A, and a locking pivotal position as seen in FIGS. 25 and 25A. In some examples, linkage also permits lateral movement of handle 85 toward and away from the inner enclosure 47 of toolbox 24. With a locking mechanism as shown in FIG. 27, handle 85 moved between a first lateral position in which handle 85 is recessed towards or within inner enclosure and a second lateral position in which handle 85 extends away from inner enclosure. When the toolbox 24 is in storage, handle 85 will be in the second lateral position and the locking pivotal position, where both the top cover 79 and the mounting lock, such as a locking assembly 46 are locked to prevent release of either top cover 79 or toolbox 24 from base 20. In the locking pivotal position, first locking element and second locking element are engaged, and handle 85 is restricted from laterally moving from the second lateral position to the first lateral position. When handle 85 is turned to the operative pivotal position, handle 85 can then be move laterally toward the first lateral position. In the first lateral position, handle 85 is restricted from pivotally moving from the operative pivotal position to the locking pivotal position. As shown in the embodiment in FIG. 27A, cantilevered panels 110 are linked to the handles 85 such that the cantilevered panels 110 release the mounting lock when the handles 85 are in the locking lateral position, and prevent the release of the mounting lock when the handles 85 are in the operative lateral position. In other examples there may be a secondary lock 49 for locking at least one of the handles in the locking pivotal position. As shown in FIG. 25, this secondary lock may be an aperture in the handle 85 sized to receive a padlock 83. It will be appreciated that other types of secondary locks may be used, for example a key lock (not shown) within handle 85 that prevents the handle from being rotated when in a locked position.

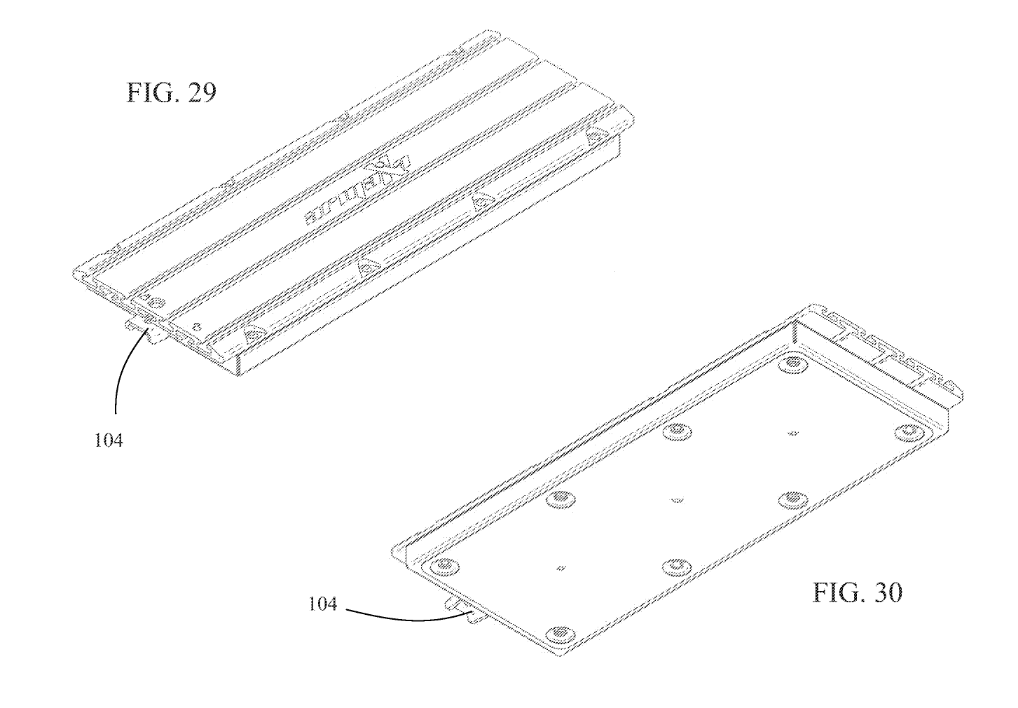

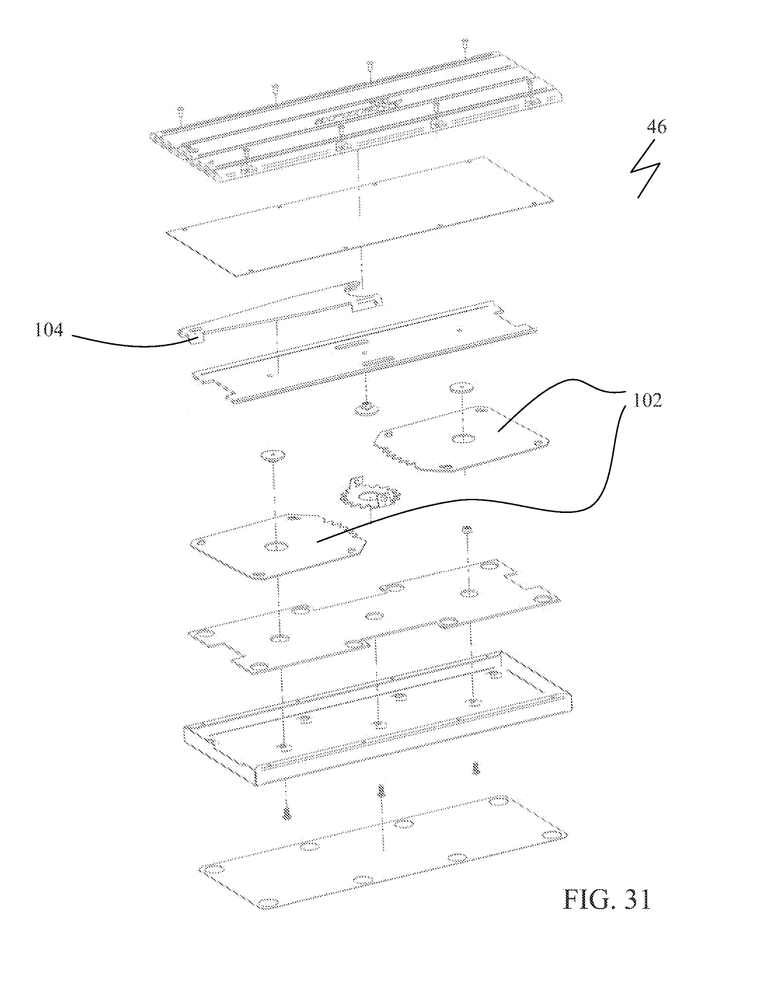

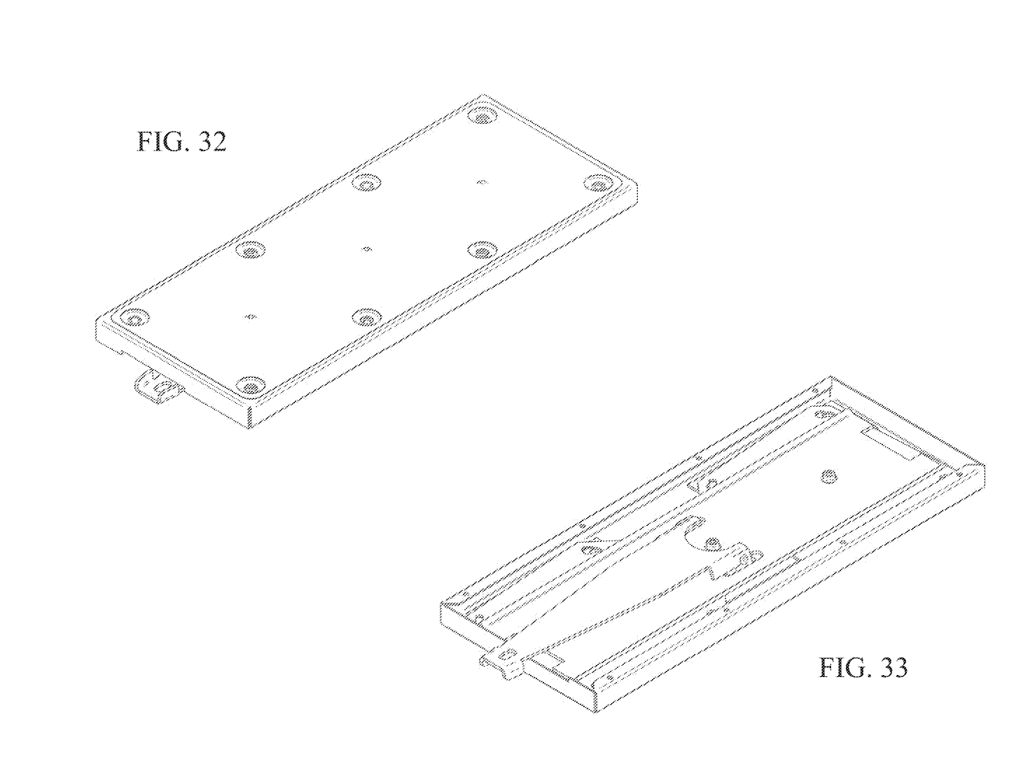

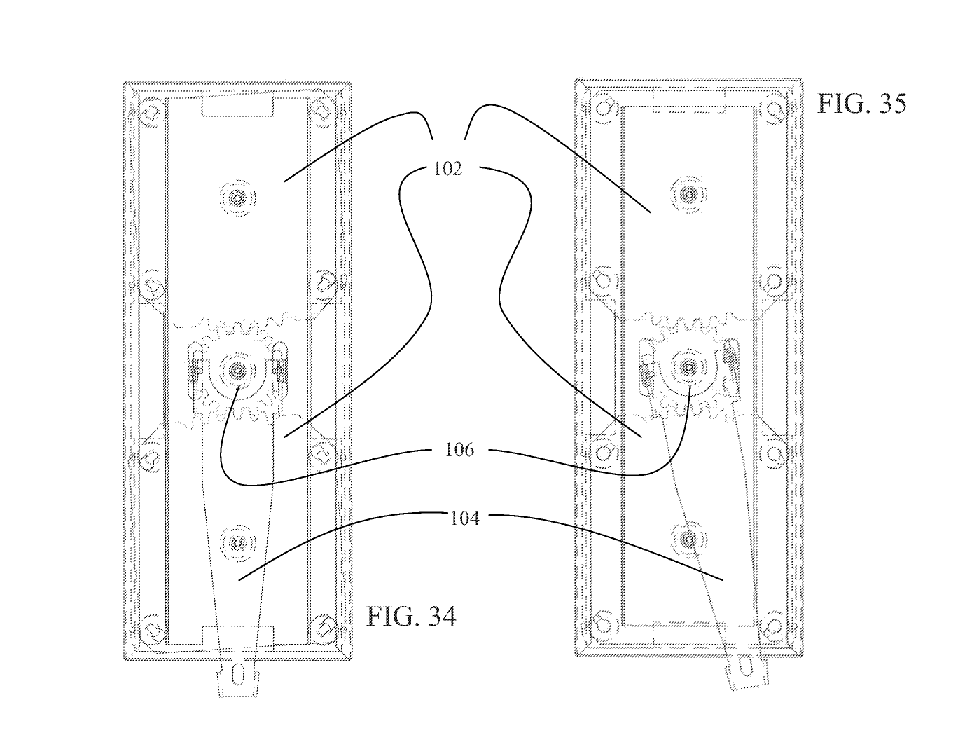

Referring to FIGS. 29-35 a further example of locking assembly 46 is shown. In the example shown in FIG. 31, locking assembly 46 has pivotally mounted catch plates 102. In the depicted example there are two pivotally mounted catch plates 102, but it will be appreciated that different numbers of catch plates 102 may be used depending on the length of locking assembly 46 and the preferences of the user. With this locking assembly 46, pivotally mounted catch plates 102 are mounted to tool box 24 or other tool accessory such that the catch plate 102 moves pivotally between a locking position and a release position. This is accomplished using lever 104. FIGS. 34 and 35 depict this rotation. It may also be possible to cause the movement by applying a force to handles 85, such as is described previously. As shown, when in the locked position, the male members 32 will be held in place by the female members 44. Moving lever 104 engages rotary actuator 106 that in turn engages each of the catch plate sections 102, the rotary actuator 106 rotating the catch plates 102 to the release position, which in turn rotates the profiles of the female members 44, aligning the profile such that male member 32 is released.

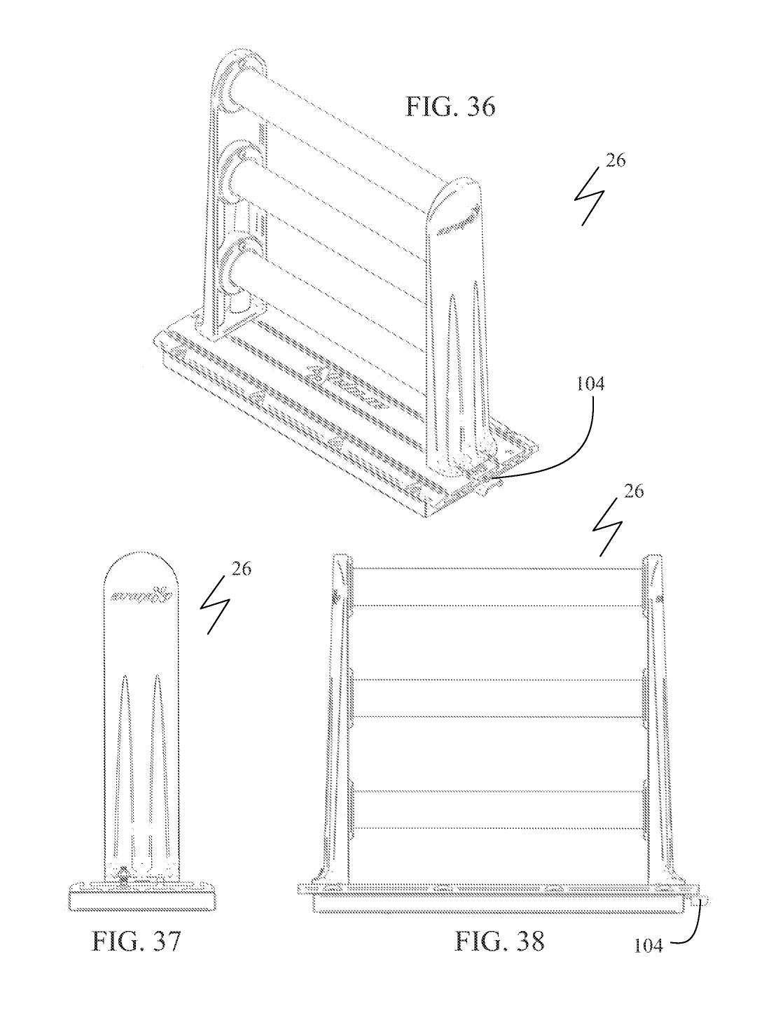

As shown in FIGS. 36-38, the alternative locking assembly 46 may also be used for the accessories. The locking assembly discussed in FIGS. 29-35 is shown, but it will be appreciated that any locking mechanism discussed may be used for both the toolboxes or the accessories or both.

There may also be handles 87 on primary tool box 20. The movement of handles 87 are shown in FIGS. 2A and 2B. As with handle 85, handles 87 are able to be pulled out and rotated to a locked, vertical position. In the locked position, handle 85 prevents drawer 40 from sliding open, and lid 40 from opening. As can be seen, handle 87 has a pin 89 that engages an aperture 91 on lid 40. For additional security, a padlock or other device may be used to secure handle 87 in the locked position. The movement of handle 85 will be similar, although there will be an additional linkage that moves catch plates 62a and 62b.

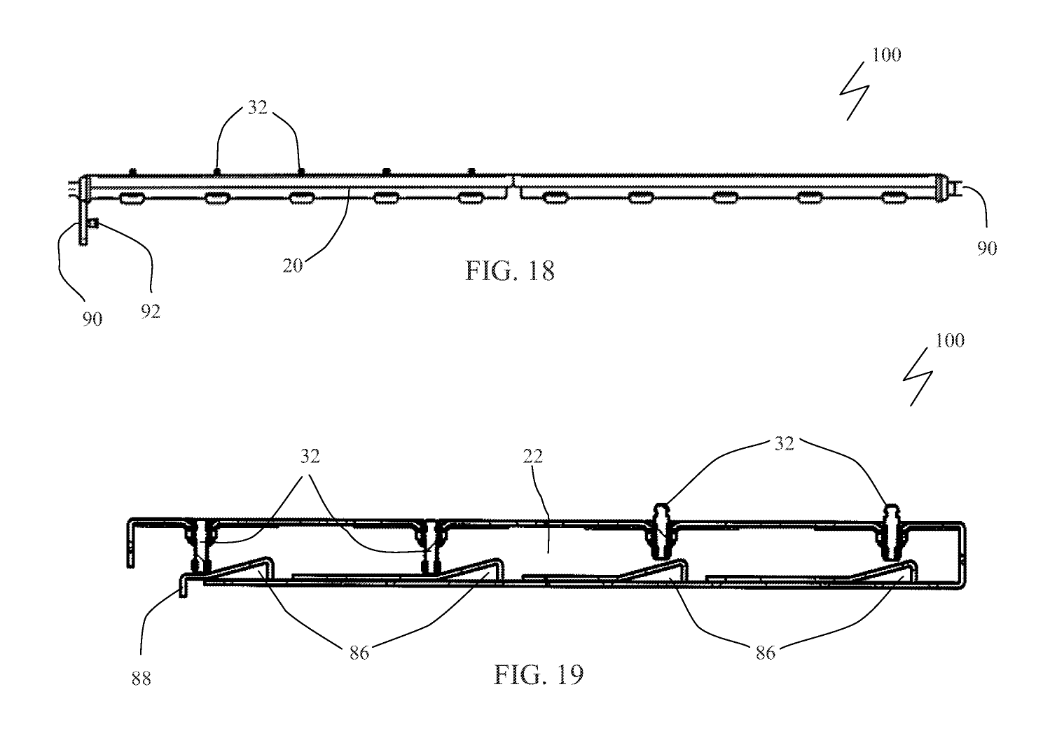

Referring to FIGS. 17 and 18, outwardly projecting male members 32 may retract within base 22. Male member 32 may be biased toward a refracted and forced outward by moving ramps 86 or other sloped surfaces, shown in FIG. 19, which move laterally within base 22. Ramps 86 may move along the length or width of base 22. As shown, ramps 86 may be connected to a handle 88 that is accessible from below. FIG. 19 shows various ramps 86 in a progression from left to right.

When used in the box of a truck, it is preferred that base 22 be a toolbox, as described above. However, referring to FIGS. 17-20, it will be understood that base 22 may not be a toolbox, but may also be a working platform, indicated by reference numeral 100. Male member 32 is shown as being retractable on base 22 when designed to be temporarily attached as a working platform. As shown in FIG. 17, working platform 100 may have hinges 93 that permit it to be folded for storage and transport. The retractable male members 32 described above are particularly useful when base 22 is intended for intermittent use only, such as with the depicted working platform. In the depicted embodiment, male members 32 are actuated in two groups, from either end of platform 100.

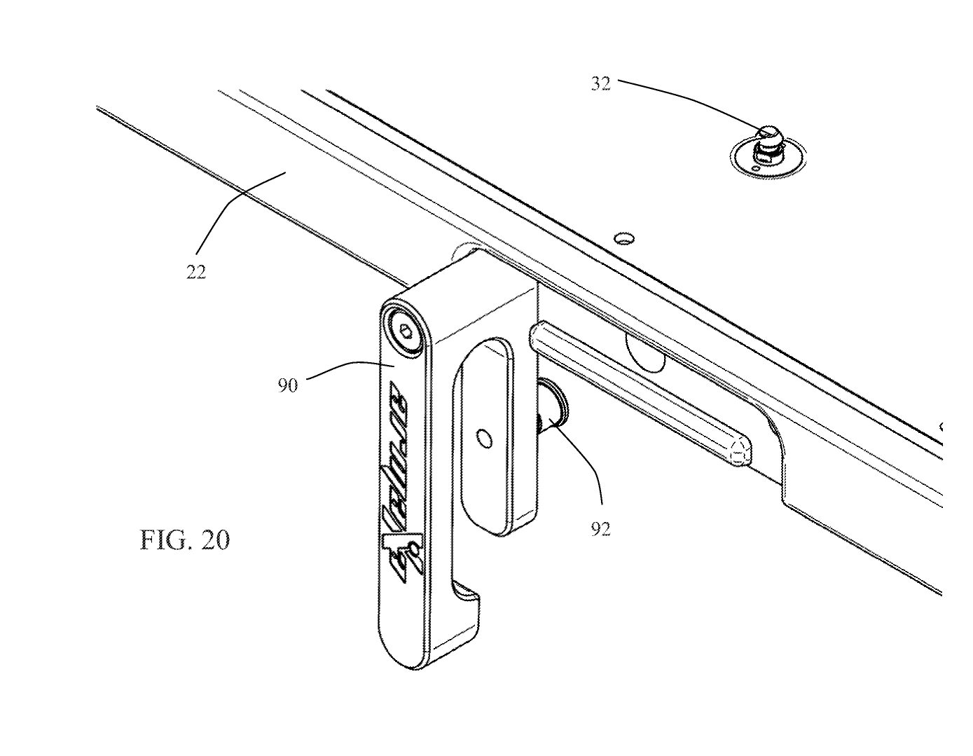

Referring to FIG. 20, platform 100 has handles 90 with an engagement pin 92 that is designed to engage the lock mechanism of a tailgate (not show). Handles 90 are movable to allow the pin to be properly engaged, and preferably also control the position of male members 32. For example, male members 32 may extend when handle 90 is pulled out, or may extend when handle is rotated down. Alternatively, there may be a separate actuator for male members 32, such as a different handle, which allows a flat surface to be available if desired, while still locking platform 100 onto the tailgate. Once attached, working platform 100 allows the tailgate to be used as a workbench with male members 32 that allow tool accessories, such as hand tools, power tools, etc. to be attached to working platform 100. Platform 100 may have a bottom surface that is designed to engage a tailgate to improve stability.

Referring to FIG. 40, base 22 may also have the form of a modular surface, such as a tile, which may be interconnected with additional modular surfaces to form a platform for mounting secondary toolboxes 24 or tool accessories. These modular surfaces need not necessarily be mounted in a truck, but may also be used as working surfaces, shelving units, etc. An embodiment of this modular surface is shown in FIG. 40 in the form of a tile 120. These tiles 120 may have interlocks 122 to engage adjacent tiles 120. FIG. 40A shows how multiple tiles may be connected together in order to form larger surfaces.

### Operation:

Locking assembly includes a movable catch that is movable between a locking position and a release position. In the locking position, the catch engages the enlarged head of each of the male members to prevent the male members from being withdrawn from the female receivers. In the release position, the catch is spaced from the enlarged heads of each of the male members.

It is preferred that the movable catch be in the form of at least one movable catch plate having catch profiles which engage the enlarged head of each of the male members in the locking position. In the preferred embodiment, there are two movable catch plate sections connected by an expandable linkage. The expandable linkage selected for illustration is a scissor linkage, although it will be appreciated that other forms of expandable linkage could have been used.

In order to maintain the two movable catch plate sections in the locking position, it is preferred that the two movable catch plate sections be biased by springs toward the locking position. This then requires that the biasing force of the springs must be overcome in order to expand the linkage and move the movable catch plate sections to the release position.

In order to prevent binding, it is preferred that the movable catch plate sections each have a slotted track and the secondary toolbox or tool accessory have a track guide configured to engage the slotted track and guide movement of the movable catch plate sections.

When it is anticipated that the apparatus will be used in adverse weather conditions, it is preferred that resilient sealing elements be positioned across each of the female recesses. Each sealing element resiliently deforming to facilitate entry of a male member. Each sealing element resiliently returns to a sealing position across the female recess when the male member is withdrawn.

In order to facilitate movement between the locking position and the release position, it is preferred that handles be provided which protrude from an exterior surface on opposed sides of the secondary toolbox or tool accessory. The handles are connected to the movable catch plate sections. A manual pulling or pushing force exerted upon the handles serves to overcome the biasing force of the springs and move the movable catch plate sections to the release position.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. An apparatus for attaching equipment, comprising:
a base having a primary engagement surface with a plurality of outwardly projecting male members each comprising a shaft with an enlarged head at a remote end;
one of a toolbox or tool accessory, the toolbox or tool accessory having a secondary engagement surface with a plurality of inwardly recessed female receivers configured to receive the male members in mating relationship; and
a locking assembly positioned within the toolbox or tool accessory, the locking assembly including a movable catch that is movable between a locking position and a release position, wherein in the locking position the catch engages the enlarged head of each of the male members to prevent the male members from being withdrawn from the female receivers, and in the release position the catch is spaced from the enlarged heads of each of the male members.

2. The apparatus of claim 1, wherein the movable catch is at least one movable catch plate having catch profiles that engage the enlarged head of each of the male members in the locking position.

3. The apparatus of claim 2, comprising two movable catch plate sections connected by an expandable linkage that moves each catch plate laterally in an opposite direction.

4. The apparatus of claim 3, wherein the expandable linkage is a scissor linkage.

5. The apparatus of claim 2, wherein the at least one movable catch plate sections are biased by springs toward the locking position, such that the biasing force of the springs must be overcome in order to move the movable catch plate sections to the release position.

6. The apparatus of claim 3, wherein each movable catch plate section has a slotted track and the secondary toolbox or tool accessory has a track guide configured to engage the slotted track and guide movement of the movable catch plate sections.

7. The apparatus of claim 5, wherein handles protrude from an exterior surface on opposed sides of the toolbox or tool accessory, the handles being connected to the movable catch plate sections, such that a manual force exerted upon the handles serves to overcome the biasing force of the springs and move the movable catch plate sections to the release position.

8. The apparatus of claim 7, wherein one of the handles has a first aperture and an immovable protuberance on the exterior of the toolbox or tool accessory has a second aperture, unauthorized removable of the secondary toolbox or tool accessory from the primary toolbox being prevented by aligning the first aperture and the second aperture and extending a padlock through the apertures to secure the handles to the immovable protuberance and prevent movement of the movable catch plate sections to the release position.

9. The apparatus of claim 7, wherein the handles are connected to the movable catch plate sections by at least one lever and the movable catch plate sections are released by pushing or pulling on the handles.

10. The apparatus of claim 2, comprising at least one catch plate section that is pivotally mounted to the toolbox or tool accessory such that the at least one catch plate section moves pivotally between the locking position and the release position.

11. The apparatus of claim 10, comprising two or more catch plate sections and a rotary actuator that engages each of the catch plate sections, the rotary actuator pivotally moving each of the catch plate sections to the release position.

12. The apparatus of claim 11, wherein the rotary actuator is actuated by a lever that extends out beyond an outer perimeter of the toolbox or tool assembly.

13. The apparatus of claim 1, wherein resilient sealing elements are positioned across each of the female recesses, each sealing element resiliently deforming to facilitate entry of a male member, each sealing element resiliently returning to a sealing position across the female recess when the male member is withdrawn.

14. The apparatus of claim 1, wherein the base is a primary toolbox and the toolbox with the secondary engagement surface is a secondary toolbox.

15. The apparatus of claim 1, wherein the base has a connection that connects to a tailgate of a truck.

16. The apparatus of claim 1, wherein the plurality of outwardly projecting male members are selectively retractable within the base.

17. The apparatus of claim 16, wherein each projecting male member is refracted and extended using a sloped surface that moves laterally within the base and applies an extending force to the corresponding projecting male member.

18. The apparatus of claim 1, wherein the tool accessory comprises at least one of a fuel container, a rack accessory, vice grips, and power tools.

19. The apparatus of claim 1, wherein the base comprises a top surface of a truck toolbox that has attachments for mounting in a box of a truck.

20. The apparatus of claim 1, wherein the base comprises a modular surface that can be connected to additional modular surfaces.

21. A toolbox, comprising:
a toolbox body having a bottom, a top cover and a surrounding sidewall, the toolbox body defining an inner enclosure, the top cover comprising a first locking element; and
at least one handle on the surrounding sidewall adjacent to the first locking element, the handle carrying a second locking element that selectively engages the first locking element, the handle being mounted to the toolbox body by a linkage, the linkage comprising:
a pivoting axis that permits pivotal movement of the handle between an operative pivotal position and a locking pivotal position; and
a sliding actuator that permits lateral movement of the handle between a first lateral position and a second lateral position, wherein, in the locking pivotal position, the handle is restricted from laterally moving from the second lateral position to the first lateral position and the second locking element engages the first locking element to fix the position of the top cover.

22. The toolbox of claim 21, further comprising a secondary lock for locking the at least one handle in the locking pivotal position.

23. The toolbox of claim 22, wherein the secondary lock comprises an aperture in the handle sized to receive a padlock.

24. The toolbox of claim 21, wherein the bottom of the toolbox body further comprises at least one mounting lock that removably locks to a locking surface, wherein movement of the at least one handle to the first lateral position releases the mounting lock from the locking surface.

25. The toolbox of claim 24, wherein, in the first lateral position, the at least one handle is retracted toward the inner enclosure and wherein each handle is connected by a lever to the respective mounting lock, such that the movement of the at least one handle to the first lateral position releases the at least one mounting lock.

26. The toolbox of claim 21, wherein, in the first lateral position, the handle is refracted toward the inner enclosure.

27. The toolbox of claim 21, wherein in the first lateral position, the handle is restricted from pivotally moving from the operative pivotal position to the locking pivotal position.
